(19) United States
(12) Patent Application Publication
(10) Pub. No.: US 2003/0102080 A1
(43) Pub. Date: Jun. 5, 2003

(54) Adhesive label, labeled item, and method for labeling item with polymer film label using water-based adhesive

(76) Inventor: Donald W. Mallik, Atlanta, GA (US)

Correspondence Address: ERINN C. KELLY, SUTHERLAND ASBILL & BRENNAN LLP, 999 Peachtree Street, NE, Atlanta, GA, 30309-3996, US

(21) Appl. No.: 10/247,874

(22) Filed: Sep. 20, 2002

Related U.S. Application Data
(60) Provisional application No. 60/336,792, filed on Dec. 5, 2001.

(51) Int. Cl. C09J 1/00

(52) U.S. Cl. 156/325; 156/328; 425/355

(57) ABSTRACT

This invention discloses a method for labeling an item wherein a sheet of polymer film is adhered to the item with a layer of water-based adhesive. The invention also discloses a label that includes a sheet of polymer film and a water-based adhesive, and a package that includes an item and a label adhered to the item. The item can be a product container such as a beverage bottle. The polymer film has a water vapor transmission rate of at least about 100 gm/m²/24 hours, and is also less than about 10,000 gm/m²/24 hours. The polymer film is also ink receptive to printing. A particularly suitable polymer film is polylactide (PLA) polymer 4040D. The sheet of polymer film has a thickness from about 0.001 to about 0.003 inches and is substantially transparent. The water-based adhesive can be a natural or synthetic adhesive, and can further include a contact sublayer and a tie sublayer. The water-based adhesive can be applied directly to the label or the item, and can be applied to the label, dried, and later reactivated at such time as the label is applied to the item.

### CROSS REFERENCE TO RELATED APPLICATION

This application claims priority Under 35 USC § 119 to U.S. provisional patent application serial No. 60/336,792 filed on Dec. 5, 2001.

### FIELD OF THE INVENTION

This invention relates to labeling items and more particularly relates to labeling with polymer film labels.

### BACKGROUND OF THE INVENTION

Cut and stack labels are often desirable for a high speed/high volume manufacturing and packaging processes such as packaged beverage manufacturing. Cut and stack labels are traditionally made from paper and applied to items using water-based adhesives because paper labels and water-based adhesives are relatively inexpensive and can be applied at a high rate.

Polymer labels, particularly clear or transparent polymer labels, are desirable in some applications. For example, clear polymer labels are desirable for bottled beverages, such as beer, for improved aesthetics. One drawback, however, is that water-based adhesives, sometimes referred to as cold glues, are not effective adhesives for conventional clear polymer film labels. When used to apply conventional polymer film labels, water-based adhesives or cold glues dry too slowly for some commercial applications.

Clear polymer film labels are sometimes applied with pressure sensitive adhesives, but conventional processes and equipment for applying clear polymer film labels to items with pressure sensitive adhesive are relatively slow. Accordingly, clear polymer film labels with pressure sensitive adhesives increase the manufacturing cost of a product and are sometimes commercially undesirable.

Therefore, what is needed in the art is a method for labeling an item using a sheet of polymer film and a water-based adhesive, whereby the water-based adhesive dries in a commercially acceptable time, desirably less than 24 hours, and the sheet of polymer film is receptive to ink printing.

### SUMMARY OF THE INVENTION

This invention encompasses a method for labeling an item comprising adhering a sheet of polymer film to the item with a layer of water-based adhesive, the sheet of polymer film having a water vapor transmission rate of at least about 100 gm/m²/24 hrs, based on a 1 mil thickness of the sheet of polymer film in accordance with ASTM Standard F-1249, and being ink receptive for printing. This invention also encompasses the resulting package comprising the item and a label adhered to the item, the label comprising a sheet of polymer film and a layer of water-based adhesive which adheres the sheet of polymer film to the item, the sheet of polymer film having a water vapor transmission rate of at least about 100 gm/m²/24 hrs and being ink receptive for printing. This invention further encompasses an adhesive label comprising a sheet of polymer film as described above and a layer of water-based adhesive which adheres the sheet of polymer film to the item. Because of the high water vapor transmission rate of the sheet of polymer film, the label of this invention can be applied with water-based adhesives or cold glues at a high rate and the water-based adhesive dries beneath the label within a commercially acceptable time frame for many commercial applications.

Conventional paper labels are porous and allow water vapor to escape. Thus, conventional paper labels applied with water-based adhesives dry quickly. Conventional clear polymer film labels do not transmit water vapor very well and as a result do not dry quickly enough for many applications. The label of this invention does dry quickly, desirably less than about 24 hours. In some preferred embodiments of this invention, the water-based adhesive dries in less than 10 hours.

Other features of preferred embodiments of this invention will be appreciated by those skilled in the art from the following description, drawings and claims.

### DETAILED DESCRIPTION OF THE FIGURES

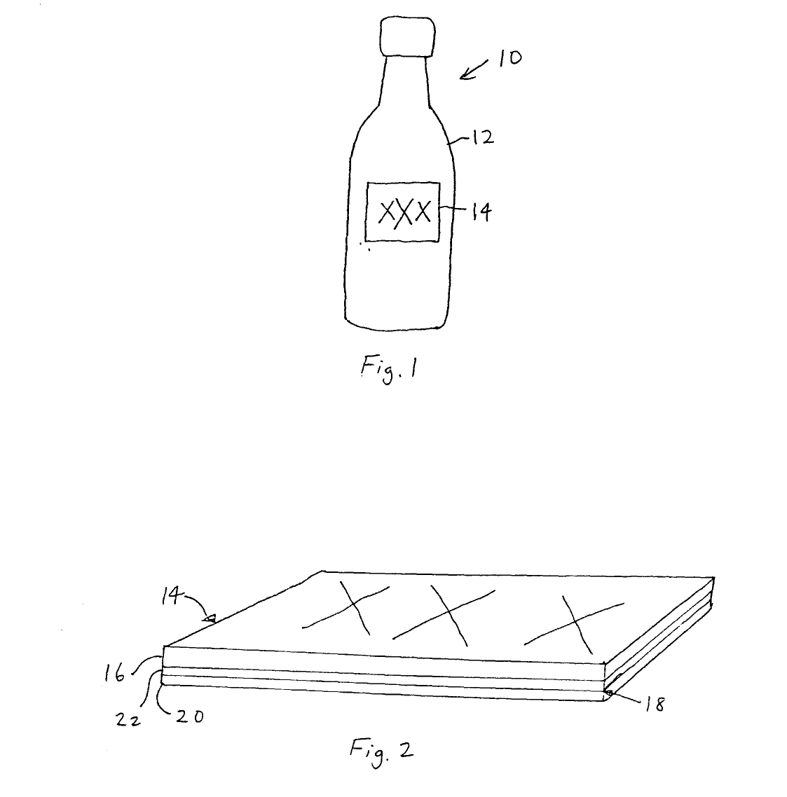

FIG. 1 is a front view of a packaged beverage having an adhesive label made according to an embodiment of the present invention placed thereon.

FIG. 2 is a three dimensional side view of an adhesive label made according to an embodiment of the present invention.

### DETAILED DESCRIPTION OF THE INVENTION

Suitable polymer films for forming labels for use in this invention generally have a moisture vapor transmission rate greater than 100 gm/m²/24 hrs, but polymer films having an even greater moisture vapor transmission rate are desirable. Generally, suitable polymer films for use in this invention have a moisture vapor transmission rate from at least about 100 gm/m²/24 hrs to about 10,000 gm/m²/24 hrs. In preferred embodiments of this invention, the label includes a polymer film having a moisture vapor transmission rate of at least about 150 gm/m²/24 hrs, even more desirably greater than about 200 gm/m²/24 hrs, still more desirably greater than about 250 gm/m²/24 hrs and preferably greater than about 300 gm/m²/24 hrs. Many suitable polymer films for the label of this invention have a moisture vapor transmission rate from at least about 100 gm/m²/24 hrs to about 500 gm/m²/24 hrs.

More particularly, suitable polymers for forming the label of this invention according to preferred embodiments include polylactide (PLA), polyethylene oxide (PEO), polyvinyl alcohol, polybutylene succinate, polycaprolactone (PCL), polyamide-polyether block copolymers, polyeurathanes, high water vapor transmission rate polyesters and copolyesters, polyethyloxazoline, acrylic acid based copolymers, cellulose derivatives such as methocellulose, hydroxypropyl cellulose, and the like, poly(butylene succinate-adipate), poly(lactic acid), polyhydroxybutyrate-covalerate, polyethylene adipate, polypropylene succinate, poly(vinyl pyrrolidone), copolymers of polyethylene oxide and polypropylene oxide, as well as blends and mixtures there of.

A particularly suitable polymer performing the polymer film label of this invention is polylactide (PLA) polymer 4040D available from Cargill Dow LLC.

The sheet of polymer film for the label of this invention can have any desired thickness provided the sheet transmits water vapor at a rate sufficient for the water-based adhesive below the polymer sheet to dry within a commercially acceptable period of time. Preferably, the polymer sheet in the label of this invention has a thickness from about 0.001″ to about 0.003″.

Although the polymer sheet for the label of this invention can be colored or opaque, it is desirably clear or substantially transparent for many applications. The polymer film sheet for the label of this invention can be perforated for even faster moisture vapor transmission, but for many labeling applications, a solid non-perforated polymer film is desirable. Thus, the water vapor transmission through the polymer film is typically by diffusion or solubility.

The polymer film for the label of this invention desirably is suitable for printing with conventional printing inks and equipment. Thus, the sheet of polymer film in the label of this invention should be ink receptive for printing and desirably is printable with conventional printing equipment and ink at a high speed so that the ink dries quickly and the image does not spread or smear.

Suitable adhesives for applying the label of this invention include water-based adhesives, which are sometimes referred to as cold glue. Suitable water-based adhesives include both natural and synthetic adhesives. In particular, suitable natural adhesives include cold glues such as animal glue, blood albumen glue, casein glue, and vegetable glues such as starch and dextrin glues. Suitable synthetic water-based adhesives include acrylic adhesives such as polyvinyl acetate based adhesives and the like.

In some embodiments, the adhesive layer can include a contact sublayer for contacting the item being labeled and a tie sublaye for bonding the contact sublayer to the sheet of polymer film. The tie sublayer comprises an adhesive that has more affinity for the sheet of polymer film than the contact sublayer. For example, suitable adhesives for the tie sublayer include the same adhesives described in the preceding paragraph.

The labels of this invention are applied with conventional water-based adhesive or cold glue labeling equipment. The water-based adhesive is deposited between the label and the item. The labels are typically applied to the product packaging, but can be applied directly to the product in some instances. For example, labels of this invention can be applied to bottles, both glass and plastic, paper boxes, and other typical product containers.

The label can be applied to an item directly with water-based adhesive in a wet state or the label can be pre-coated with the water-based adhesive and dried for later application to the item by reactivating the adhesive such as with water and adhering the activated label to the item. For example, the label can be printed and die cut without the application of an adhesive and then fed from a magazine in a labeling line where the water-based adhesive is applied directly to the label or the item and the label is adhered to the item. Alternatively, the water-based adhesive can be applied to the label and dried. The adhesive label is then die cut and can be fed from a magazine to a labeling line, reactivated with water, and adhered to the item

As an example of an embodiment of this invention, a bottle label was simulated by applying a layer of Henkel cold glue No. 10-7302M to a piece of flat glass with a number 12 wire wound rod coater. A 0.001 inch thick layer of oriented PLA film was quickly laminated to the wet glue. When the glue contains water, it has a milky appearance and when the water is dissipated, the glue becomes clear. In less than 5 hours, the glue was completely clear, indicating that the water had diffused through the film and into the atmosphere. When the same experiment was conducted using an oriented polypropylene film, the glue remained milky for more than two days. The very high MVTR of the PLA film allowed the water to escape more quickly. Polystyrene and polyester films have higher MVTR than polypropylene, but are far lower than PLA.

An embodiment is illustrated in FIGS. 1 and 2. In FIG. 1, a packaged beverage 10 comprises a bottle 12 and a printed label 14 attached to the bottle. The label 14 is best illustrated in FIG. 2 and comprises a sheet of polymer film 16 as described above and a layer of water-based adhesive 18 which adheres the sheet of polymer film to the bottle 12. The layer of water-based adhesive 18 comprises two sublayers including a contact sublayer 20 and a tie sublayer 22.

While this invention has been described in detail with respect to particular embodiments thereof, it will be appreciated that those of ordinary skill in the art, upon obtaining an understanding of the foregoing, will readily conceive of alterations to, and variations of, and equivalents to these embodiments, and that numerous changes may be made therein without departing from the scope of the invention as defined by the following claims.

I claim:

1. A method for labeling an item comprising adhering a sheet of polymer film to the item with a layer of water-based adhesive, wherein the sheet of polymer film has a water vapor transmission rate of at least about 100 gm/m²/24 hours and is ink receptive for printing.

2. The method of claim 1 wherein the sheet ofpolymer film has a water vapor transmission rate of at least about 150 gm/m²/24 hours.

3. The method of claim 1 wherein the sheet of polymer film has a water vapor transmission rate of at least about 200 gm/m²/24 hours.

4. The method of claim 1 wherein the sheet of polymer film has a water vapor transmission rate of at least about 250 gm/m²/24 hours.

5. The method of claim 1 wherein the sheet of polymer film has a water vapor transmission rate of at least about 300 gm/m²/24 hours.

6. The method of claim 1 wherein the sheet of polymer film has a water vapor transmission rate of less than about 10,000 gm/m²/24 hours.

7. The method of claim 1 wherein the sheet of polymer film has a water vapor transmission rate of less than about 500 gm/m²/24 hours.

8. The method of claim 1 wherein the sheet of polymer film is made from a polymer selected from the group consisting of polylactide, polyethylene oxide, polyvinyl alcohol, polybutylene succinate, polycaprolactone, polyamide-polyether block copolymers, polyeurathanes, high water vapor transmission rate polyesters and copolyesters, polyethyloxazoline, acrylic acid based copolymers, cellulose derivatives such as methocellulose, hydroxypropyl cellulose, and the like, poly(butylene succinate-adipate), poly(lactic acid), polyhydroxybutyrate-covalerate, polyethylene adipate, polypropylene succinate, poly(vinyl pyrrolidone), copolymers of polyethylene oxide and polypropylene oxide, and blends and mixtures thereof.

9. The method of claim 8 wherein the sheet of polymer film is made from polylactide polymer.

10. The method of claim 1 wherein the sheet of polymer film has a thickness from about 0.001 to about 0.003 inches.

11. The method of claim 1 wherein the water-based adhesive is a natural adhesive.

12. The method of claim 11 wherein the water-based adhesive is selected from the group consisting of animal glue, blood albumen glue, casein glue, and vegetable glues.

13. The method of claim 12 wherein the vegetable glue is a starch glue.

14. The method of claim 12 wherein the vegetable glue is a dextrin glue.

15. The method of claim 1 wherein the water-based adhesive is a synthetic adhesive.

16. The method of claim 15 wherein the synthetic adhesive is an acrylic adhesive.

17. The method of claim 16 wherein the acrylic adhesive is a polyvinyl acetate based adhesive.

18. The method of claim 1 wherein the water-based adhesive comprises a contact sublayer and a tie sublayer.

19. The method of claim 1 wherein the water-based adhesive is dried on the label and capable of being reactivated at such time as the label is adhered to the item.

20. The method of claim 1 wherein the item is a product container.

21. The method of claim 20 wherein the item is a beverage bottle.

22. The method of claim 1 wherein the sheet of polymer film is substantially transparent.

23. The method of claim 1 wherein the sheet of polymer film is perforated.

24. A package comprising an item and a label adhered to the item, the label comprising a sheet of polymer film and a layer of water-based adhesive which adheres the sheet of polymer film to the item, the sheet of polymer film having a water vapor transmission rate of at least about 100 gm/m²/24 hours and being ink receptive for printing.

25. The package of claim 24 wherein the sheet of polymer film has a water vapor transmission rate of at least about 150 gm/m²/24 hours.

26. The package of claim 24 wherein the sheet of polymer film has a water vapor transmission rate of at least about 200 gm/m²/24 hours.

27. The package of claim 24 wherein the sheet of polymer film has a water vapor transmission rate of at least about 250 gm/m²/24 hours.

28. The package of claim 24 wherein the sheet of polymer film has a water vapor transmission rate of at least about 300 gm/m²/24 hours.

29. The package of claim 24 wherein the sheet of polymer film has a water vapor transmission rate of less than about 10,000 gm/m²/24 hours.

30. The package of claim 24 wherein the sheet of polymer film has a water vapor transmission rate of less than about 500 gm/m²/24 hours.

31. The package of claim 24 wherein the sheet of polymer film is made from a polymer selected from the group consisting of polylactide, polyethylene oxide, polyvinyl alcohol, polybutylene succinate, polycaprolactone, polyamide-polyether block copolymers, polyeurathanes, high water vapor transmission rate polyesters and copolyesters, polyethyloxazoline, acrylic acid based copolymers, cellulose derivatives such as methocellulose, hydroxypropyl cellulose, and the like, poly(butylene succinate-adipate), poly(lactic acid), polyhydroxybutyrate-covalerate, polyethylene adipate, polypropylene succinate, poly(vinyl pyrrolidone), copolymers of polyethylene oxide and polypropylene oxide, and blends and mixtures thereof.

32. The package of claim 31 wherein the sheet of polymer film is made from polylactide polymer.

33. The package of claim 24 wherein the sheet of polymer film had a thickness from about 0.001 to about 0.003 inches.

34. The package of claim 24 wherein the water-based adhesive is a natural adhesive.

35. The package of claim 34 wherein the water-based adhesive is selected from the group consisting of animal glue, blood albumen glue, casein glue, and vegetable glues.

36. The package of claim 35 wherein the vegetable glue is a starch glue.

37. The package of claim 35 wherein the vegetable glue is a dextrin glue.

38. The package of claim 24 wherein the water-based adhesive is a synthetic adhesive.

39. The package of claim 38 wherein the synthetic adhesive is an acrylic adhesive.

40. The package of claim 39 wherein the acrylic adhesive is a polyvinyl acetate based adhesive.

41. The package of claim 24 wherein the water-based adhesive comprises a contact sublayer and a tie sublayer.

42. The package of claim 24 wherein the water-based adhesive is dried on the label and capable of being reactivated at such time as the label is adhered to the item.

43. The package of claim 24 wherein the item is a product container.

44. The package of claim 43 wherein the item is a beverage bottle.

45. The package of claim 24 wherein the sheet of polymer film is substantially transparent.

46. The package of claim 24 wherein the sheet of polymer film is perforated.

47. An adhesive label comprising a sheet of polymer film having a water vapor transmission rate of at least about 100 gm/m²/24 hours and being ink for adhering adheres the sheet of polymer film to an item.

48. The adhesive label of claim 47 wherein the sheet of polymer film has a water vapor transmission rate of at least about 150 gm/m²/24 hours.

49. The adhesive label of claim 47 wherein the sheet of polymer film has a water vapor transmission rate of at least about 200 gm/m²/24 hours.

50. The adhesive label of claim 47 wherein the sheet of polymer film has a water vapor transmission rate of at least about 250 gm/m²/24 hours.

51. The adhesive label of claim 47 wherein the sheet of polymer film has a water vapor transmission rate of at least about 300 gm/m²/24 hours.

52. The adhesive label of claim 47 wherein the sheet of polymer film has a water vapor transmission rate of less than about 10,000 gm/m²/24 hours.

53. The adhesive label of claim 47 wherein the sheet of polymer film has a water vapor transmission rate of less than about 500 gm/m²/24 hours.

54. The adhesive label of claim 47 wherein the sheet of polymer film is made from a polymer selected from the group comprising polylactide, polyethylene oxide, polyvinyl alcohol, polybutylene succinate, polycaprolactone, polyamide-polyether block copolymers, polyeurathanes, high water vapor transmission rate polyesters and copolyesters, polyethyloxazoline, acrylic acid based copolymers, cellulose derivatives such as methocellulose, hydroxypropyl cellulose, and the like, poly(butylene succinate-adipate), poly(lactic acid), polyhydroxybutyrate-covalerate, polyethylene adipate, polypropylene succinate, poly(vinyl pyrrolidone), copolymers of polyethylene oxide and polypropylene oxide, and blends and mixtures thereof.

55. The adhesive label of claim 54 wherein the sheet of polymer film is made from polylactide polymer.

56. The adhesive label of claim 47 wherein the sheet of polymer film had a thickness from about 0.001 to about 0.003 inches.

57. The adhesive label of claim 47 wherein the water-based adhesive is a natural adhesive.

58. The adhesive label of claim 57 wherein the water-based adhesive is selected from the group consisting of animal glue, blood albumen glue, casein glue, and vegetable glues.

59. The adhesive label of claim 58 wherein the vegetable glue is a starch glue.

60. The adhesive label of claim 58 wherein the vegetable glue is a dextrin glue.

61. The adhesive label of claim 47 wherein the water-based adhesive is a synthetic adhesive.

62. The adhesive label of claim 61 wherein the synthetic adhesive is an acrylic adhesive.

63. The adhesive label of claim 62 wherein the acrylic adhesive is a polyvinyl acetate based adhesive.

64. The adhesive label of claim 47 wherein the water-based adhesive comprises a contact sublayer and a tie sublayer.

65. The adhesive label of claim 47 wherein the water-based adhesive is dried on the label and capable of being reactivated at such time as the label is adhered to the item.

66. The adhesive label of claim 47 wherein the item is a product container.

67. The adhesive label of claim 66 wherein the item is a beverage bottle.

68. The adhesive label of claim 47 wherein the sheet of polymer film is substantially transparent.

69. The adhesive label of claim 47 wherein the sheet of polymer film is perforated.
